(19) United States
(12) Patent Application Publication
(10) Pub. No.: US 2013/0174022 A1
(43) Pub. Date: Jul. 4, 2013

(54) Method and System for Adjusting Spacing Between Characters

(71) Applicants: Peking University Founder Group Co., Ltd., Beijing (CN); Peking University, Beijing (CN); Beijing Founder Electronics Co., Ltd., Beijing (CN)

(72) Inventors: Lining XIA, Beijing (CN); Ying WANG, Beijing (CN); Yingmin TANG, Beijing (CN)

(73) Assignees: PEKING UNIVERSITY FOUNDER GROUP CO., LTD., Beijing (CN); BEIJING FOUNDER ELECTRONICS CO., LTD., Beijing (CN); PEKING UNIVERSITY, Beijing (CN)

(21) Appl. No.: 13/731,845

(22) Filed: Dec. 31, 2012

(30) Foreign Application Priority Data
Dec. 31, 2011 (CN) 201110460594.0

(51) Int. Cl. G06F 17/21

(52) U.S. Cl. CPC G06F 17/211
USPC 715/244

(57) ABSTRACT

A method for adjusting spacing between characters comprises determining a character pair from a font kit. The character pair comprises two characters and has a spacing value. The method further comprises acquiring glyph outline data of the character pair, plotting the glyph outline data of the character pair, displaying the character pair on an interface, adjusting the spacing value from a first spacing value to a second spacing value, and changing, while adjusting the spacing value, a spacing between the two characters displayed on the interface along with a change of the spacing value.

### RELATED APPLICATIONS

This application is based upon and claims the benefit of priority from Chinese Patent Application No. 201110460594.0 filed on Dec. 31, 2011, the entire contents of which are incorporated herein by reference.

### TECHNOLOGY FIELD

The present disclosure relates to computer and, more particularly, to a method and a system for adjusting spacing between a pair of characters.

### BACKGROUND

As computer technology continuously improves, it not only assists people in work and life, but also provides enjoyment for people. An example of this is the display effect of characters on a computer. In a practical application, according to actual need, an ordinary character on a computer may be converted into a word art, ordinary characters may be typeset differently, or spacing between characters may be adjusted.

Conventionally, a default value is used for the spacing between two characters, especially for ASCII characters and symbols. However, some manufacturers may wish to adjust the spacing between certain characters so that when being displayed, they do not look too close to or far away from each other. For example, if the distance between a pair of characters A and V is the same as that between a pair of characters A and K, the characters A and V may appear to be farther away from each other as compared to the characters A and K. Therefore, the distance between the pair of characters A and V may need to be reduced to make them appear to be closer to each other.

A conventional method for solving the above-mentioned problem may include exporting the KERN table comprising information about spacing between characters from a font kit, changing the value of spacing stored in the KERN table, importing the changed KERN table back to the font kit, installing the font kit in a computer system, and checking the effect after the change. If the effect is not satisfactory, the above steps are repeated.

### SUMMARY

In accordance with the disclosure, there is provided a method for adjusting spacing between characters comprising determining a character pair from a font kit. The character pair comprises two characters and has a spacing value. The method further comprises acquiring glyph outline data of the character pair, plotting the glyph outline data of the character pair, displaying the character pair on an interface, adjusting the spacing value from a first spacing value to a second spacing value, and changing, while adjusting the spacing value, a spacing between the two characters displayed on the interface along with a change of the spacing value.

Also in accordance with the disclosure, there is provided a system for adjusting spacing between characters comprising a determining module configured to determine a character pair from a font kit. The character pair comprises two characters and has a spacing value. The system further comprises an acquiring module configured to acquire glyph outline data of the character pair, a plotting module configured to plot the glyph outline data of the character pair and display the character pair on an interface, and a first adjusting module configured to adjust the spacing value of the character pair from a first spacing value to a second spacing value, and change, while adjusting the spacing value, a spacing between the two characters displayed on the interface along with a change of the spacing value.

Also in accordance with the disclosure, there is provided a non-transitory computer-readable storage medium with an executable program stored thereon, wherein the program, when executed by at least one processor, causes a computing device to perform operations comprising determining a character pair from a font kit. The character pair comprises two characters and has a spacing value. The operations further comprise acquiring glyph outline data of the character pair, plotting the glyph outline data of the character pair, displaying the character pair on an interface, adjusting the spacing value from a first spacing value to a second spacing value, and changing, while adjusting the spacing value, a spacing between the two characters displayed on the interface along with a change of the spacing value.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flowchart illustrating a method for adjusting spacing between characters according to an exemplary embodiment.

FIG. 2 is a block diagram illustrating a system for adjusting spacing between characters according to an exemplary embodiment.

FIG. 3 is a diagram illustrating a result previewed before the spacing value of the character pair A and V is adjusted.

FIG. 4 is a diagram illustrating a result previewed after the spacing value of the character pair A and V is adjusted.

### DETAILED DESCRIPTION

Hereinafter, embodiments consistent with the disclosure will be described with reference to drawings. Wherever possible, the same reference numbers will be used throughout the drawings to refer to the same or like parts.

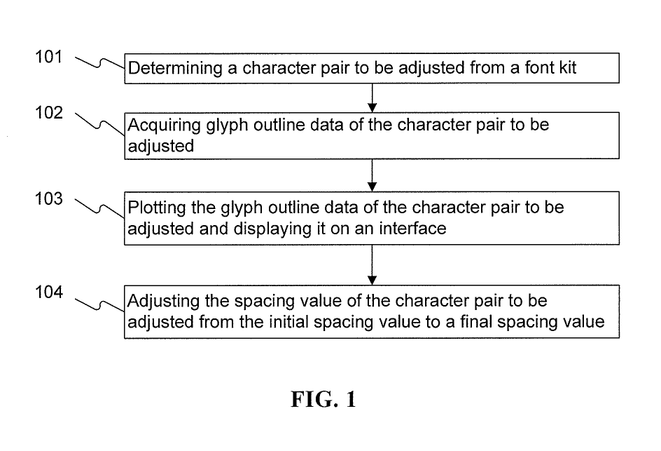

FIG. 1 shows a method for adjusting a spacing of a character pair consistent with embodiments of the present disclosure. At Step 101, a character pair, in which a spacing between characters needs to be adjusted, may be determined from a font kit. The character pair to be adjusted may include at least two characters.

Often, different font kit vendors may have different approaches of generating font kits, with each font kit having a corresponding base. In some embodiments, the font kit from which the character pair to be adjusted is selected may be an ordinary font kit prepared in advance, such as the Truetype font kit. The Truetype font kit has a corresponding base, such as 256 or 1000. The base of 256 or 1000 indicates that both a length and a width of a frame for one character in the font kit are 256 or 1000. In the embodiments described below, the Truetype font kit will be used as an exemplary font kit. However, it is noted that the method and system disclosed here also apply to other font kits.

After the Truetype font kit is prepared, the character pairs to be adjusted are determined. In some embodiments, codes of the character pairs whose spacing is improper may be extracted from the Truetype font kit and saved in a file, according to the user's need and characteristics of the Truetype font kit itself.

Taking the character pair A and V in the Truetype font kit as an example, if a distance between the characters A and V is the same as that between a pair of characters A and K, for example, if both are 40, the characters A and V may seem to be too far away from each other. Thus, the code of the character pair A and V may be extracted and saved in a file, with a file name of, for example, “File Needs to be Adjusted”.

At Step 102, glyph outline data of the character pair to be adjusted is acquired.

In some embodiments, acquiring the glyph outline data of the character pair to be adjusted may include reading out coding information of the character pair to be adjusted, and reading out the glyph outline data of the character pair to be adjusted from the font kit according to the coding information.

Specifically, the coding information of the character pair to be adjusted may be read out by reading out character codes of the character pair directly from the saved file, e.g., the file named “File Needs to Be Adjusted.” For example, the coding information of the character pair A and V may be read out by reading out character codes of the character pair A and V to be adjusted directly from, e.g., the file named “File Needs to Be Adjusted.”

After the character codes of the character pair, for example, the character codes of the character pair A and V, are read out, the glyph outline data of the character pair, e.g., the character pair A and V, may be read out from the Truetype font kit according to the character codes. A glyph of a character in the Truetype font kit comprises an outline, and the outline comprises dots. Thus, when reading out the glyph outline data, only coordinates of the dots forming the glyph and associated properties thereof, such as structure, need to be read out. The coordinates of the dots and associated properties are then saved in a memory.

In some embodiments, the coordinates used by the glyph outline in the font kit may be proportional to the base of the font kit. For example, if the base of the font kit is 256 and the horizontal coordinate of a dot of a character in the font kit is 128, then the horizontal position of the dot of the character is in the center of the frame of the character.

At Step 103, the glyph outline data of the character pair to be adjusted may be plotted and displayed on an interface. For example, FIG. 3 shows a character pair A and V displayed on the interface before being adjusted. The character pair may have a spacing value associated therewith, which represents spacing between characters in the character pair. An initial spacing value of the character pair to be adjusted, which is the spacing value of the character pair to be adjusted before being adjusted, may be a first spacing value.

In some embodiments, plotting the glyph outline data of the character pair to be adjusted may include: plotting the readout glyph outline data of the character pair by drawing according to a spacing value of an existing character pair in the font kit. If the spacing value of the existing character pair has not been set, the spacing value may be set to be 0 by default.

In some embodiments, each existing character pair in the Truetype font kit may have a preset spacing value. For example, a spacing value of an existing character pair M and N may be 26. The spacing value the character pair to be adjusted, such as character pair A and V which has a spacing value of 40, may be adjusted according to the spacing value, i.e., 26, of the existing character pair. The spacing value of the character pair A and V, which is 40, is the first spacing value. During the adjustment process, for example, if the spacing value of the character pair A and V is 40 and the base of the font kit is 256, then such a combination represents that the spacing between the characters in the character pair is 40/256 of a character width.

Consistent with embodiments of the present disclosure, coordinates of the dots of the glyph and associated properties saved in the memory are plotted, and the character pair is displayed on the interface according to the spacing value of the character pair, so as to be previewed by the user. Specifically, the dots are connected according to the coordinates thereof, forming a closed outline. Then the closed outline is filled and such that the glyph is plotted on the interface.

At Step 104, the spacing value of the character pair to be adjusted is adjusted from the initial spacing value to a final spacing value. During the adjustment, the spacing between the characters in the character pair to be adjusted, which is displayed on the interface, will be changed along with the change of the spacing value.

In some embodiments, adjusting the spacing value of the character pair to be adjusted from the initial spacing value to the final spacing value may include adjusting the spacing value from the initial spacing value, i.e., the first spacing value, to a second spacing value, and determining whether the second spacing value satisfies preset criteria. If the second spacing value satisfies the preset criteria, save the second spacing value as the final spacing value. If the second spacing value does not satisfy the preset criteria, further adjust the spacing value from the second spacing value to a third spacing value, and determine whether the third spacing value satisfies the preset criteria. Repeat the adjusting and determining until an N-th spacing value that satisfies the preset criteria is obtained and then save the N-th spacing value as the final spacing value, where N is an integer larger than 2.

In some embodiments, the preset criteria are criteria that satisfy the user. For example, the spacing value of the character pair to be adjusted, such as A and V, may be adjusted from the first spacing value, such as 40, to the second spacing value, such as 26. If the display effect of the character pair to be adjusted on the interface, which now has the second spacing value, satisfies the user, the spacing value may not need to be adjusted any more. The character pair A and V, and the second spacing value as the final spacing value, may be saved. If the spacing value is 26, and the base of the font kit is 256, such a combination indicates that the spacing between the characters in the character pair 26/256 of a character width. That is, when the spacing value of the character pair A and V is adjusted from the first spacing value of 40 to the second spacing value of 26, the spacing between the characters in the character pair is reduced by 40/256−26/256=14/256. In other words, after the adjustment, a distance between the characters A and V in the character pair is reduced by 14/256.

In some embodiments, saving the character pair A and V and the second spacing value may include: acquiring character codes of the character pair A and V and the second spacing value; and converting the character codes into corresponding indexes according to a code table of the Truetype font kit. For example, if the character code of the character A is a and the character code of the character V is v, then after the conversion, the index corresponding to the character code a may be al and the index corresponding to the character code v may be v1, and the indexes al and v1 together form an index pair. Saving the character pair A and V and the second spacing value may further include saving the index pair and the second spacing value as the final spacing value in the KERN table of the Truetype font kit.

In some embodiments, after the spacing value of the character pair to be adjusted, such as A and V, is adjusted from the first spacing value, such as 40, to the second spacing value, such as 26, if the display effect of the character pair to be adjusted displayed on the interface does not satisfy the user, the spacing value may need to be further adjusted. Such adjustment may be repeated until an N-th spacing value that satisfies the preset criteria is obtained, where the first spacing value is larger than the second spacing value, and the second spacing value is larger than the third spacing value ((N−1)th spacing value larger than the N-th spacing value).

In some embodiments, during the process of adjusting the spacing value to the N-th spacing value that satisfies the preset criteria, the spacing between the characters in the character pair, such as A and V, displayed on the interface may be changed when the spacing value of the character pair is adjusted. For example, when the spacing value of the character pair A and V is adjusted from 40 to 26, the spacing between the characters A and V displayed on the interface may also be changed from 40 to 26. For example, FIG. 4 shows the character pair A and V being displayed after the spacing value associated therewith is adjusted. In the process of adjusting the spacing value of the character pair A and V, both the base and the frame of the character in the font kit may not change.

In some embodiments, adjusting the spacing value to the N-th spacing value that satisfies the preset criteria may include: adjusting the spacing value of the character pair to be adjusted by a positive number or a negative number; adjusting positions of the characters in the character pair according to the adjusted spacing value, and re-plotting by drawing according to the adjusted spacing value to obtain a plotting result; and adjusting the spacing value according to the plotting result until the N-th spacing value that satisfies the preset criteria is obtained.

In some embodiments, during the adjustment process, adjusting the spacing value may include making numerical change according to an adjusting interface for the spacing value. A positive number may represent increasing the spacing between the characters, and a negative number may represent decreasing the spacing between the characters.

According to the adjusted spacing value, Step 103 may be repeated to plot the glyphs of the characters on the interface to obtain a plotting result. According to the plotting result, it may be determined whether the glyphs meet the user's criteria. If the plotting result meets the user's criteria, then the adjusted spacing value may not be further changed, and the adjusted spacing value (as the final spacing value) and the corresponding character pair may be saved. If the plotting result does not meet the user's criteria, then Step 104 may be repeated to adjust the spacing value until the adjusted spacing value satisfies the user's criteria. The spacing value that satisfies the user's criteria and the corresponding pair of characters are saved, and the glyphs of the characters corresponding to the adjusted spacing value are plotted on the interface to be previewed by the user. In some embodiments, the saving may include: acquiring the character codes of the character pair A and V and the adjusted spacing value (now the final spacing value); converting the character codes into corresponding indexes according to the code table of the Truetype font kit; and saving the spacing value and an index pair comprising the corresponding indexes in the KERN table of the Truetype font kit.

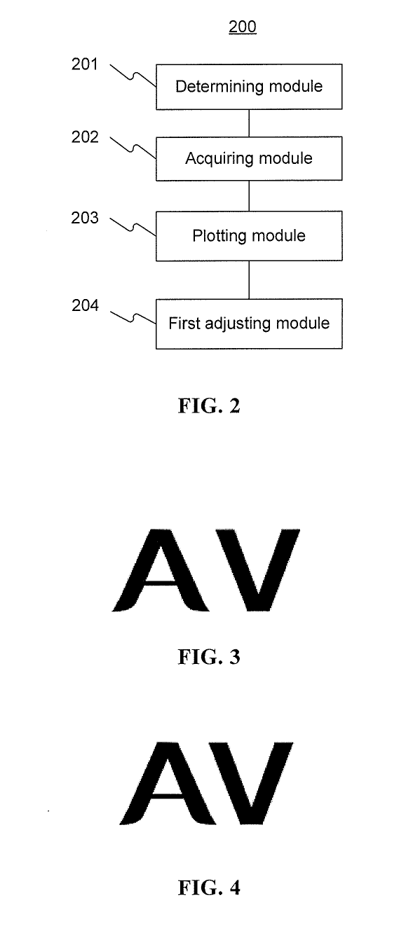

Now referring to FIG. 2, it shows a system 200 for adjusting spacing values of character pairs. The system 200 may be a hardware system comprising multiple hardware modules. As shown in FIG. 2, the system 200 comprises a determining module 201, configured to determine a character pair to be adjusted, in which a spacing between characters needs to be adjusted, from a font kit. The character pair to be adjusted may include at least two characters.

Different font kit vendors may have different approaches of generating font kits, with each font kit having a corresponding base. In some embodiments, the font kit from which the character pair to be adjusted is selected may be an ordinary font kit prepared in advance, such as the Truetype font kit. The Truetype font kit has a corresponding base, such as 256 or 1000. Wherein, the base of 256 or 1000 indicates that both a length and a width of a frame for one character in the font kit are 256 or 1000. In the embodiments described below, Truetype font kit will be used as an exemplary font kit. However, it is noted that the method and system disclosed here also apply to other font kits.

After the Truetype font kit is prepared, the character pairs needs to be adjusted may be determined. In some embodiments, codes of the character pairs whose spacing is improper may be extracted from the Truetype font kit and saved in a file, according to the user's need and characteristics of the Truetype font kit itself.

Taking the character pair A and V in the Truetype font kit as an example, if a distance between the characters A and V is the same as that between a pair of characters A and K, for example, if both are 40, the characters A and V may seem to be too far away from each other. Thus, the code of the character pair A and V may be extracted and saved in a file, with a file name of, for example, “File Needs to be Adjusted”.

The system 200 may also comprise an acquiring module 202 configured to acquire glyph outline data of the character pair to be adjusted.

In some embodiments, the acquiring module 202 may comprise a first acquiring sub-module (not shown) and a second acquiring sub-module (not shown). The first acquiring sub-module may be configured to read out coding information of the character pair to be adjusted, and the second acquiring sub-module may be configured to read out the glyph outline data of the character pair to be adjusted from the font kit according to the coding information.

Specifically, the coding information of the character pair to be adjusted may be read out by reading out character codes of the character pair directly from the saved file, e.g., the file named “File Needs to Be Adjusted.” For example, the coding information of the character pair A and V may be read out by reading out character codes of the character pair A and V to be adjusted directly from, e.g., the file named “File Needs to Be Adjusted.”

After the character codes of the character pair, for example, the character codes of the character pair A and V, are read out, the glyph outline data of the character pair, e.g., the character pair A and V, is read out from the Truetype font kit according to the character codes. A glyph of a character in the Truetype font kit comprises an outline, and the outline comprises dots. Thus, when reading out the glyph outline data, only coordinates of the dots forming the glyph and associated properties thereof, such as structure, need to be read out. The coordinates of the dots and associated properties thereof are then saved in a memory.

In some embodiments, the coordinates used by the glyph outline in the font kit may be proportional to the base of the font kit. For example, if the base of the font kit is 256 and the horizontal coordinate of a dot of a character in the font kit is 128, then the horizontal position of the dot of the character is in the center of the frame of the character.

The system 200 may further comprise a plotting module 203 configured to plot the glyph outline data of the character pair to be adjusted and display the data via an interface. An initial spacing value of the character pair to be adjusted may be a first spacing value.

In some embodiments, plotting the glyph outline data of the character pair to be adjusted may include: plotting the readout glyph outline data of the character pair by drawing according to a spacing value of an existing character pair in the font kit. If the spacing value of the existing character pair has not been set, the spacing value may be set to be 0 by default.

In some embodiments, each existing character pair in the Truetype font kit may have a preset spacing value. For example, a spacing value of an existing character pair M and N may be 26. The spacing value the character pair to be adjusted, such as character pair A and V which has a spacing value of 40, may be adjusted according to the spacing value, i.e., 26, of the existing character pair. The spacing value of the character pair A and V, which is 40, is the first spacing value. During the adjustment process, for example, if the spacing value of the character pair A and V is 40 and the base of the font kit is 256, then such a combination indicates that the spacing between the characters in the character pair is 40/256 of a character width.

When the first spacing value is being adjusted, coordinates of the dots of the glyph and associated properties thereof saved in the memory may be plotted, and the character pair may be displayed on the interface according to the spacing value of the character pair, so as to be previewed by the user. Specifically, the dots may be connected according to the coordinates thereof, forming a closed outline. Then the closed outline may be filled and such that the glyph may be plotted on the interface.

The system 200 may further comprise a first adjusting module 204 configured to adjust the spacing value of the character pair to be adjusted from the first spacing value to a final spacing value. During the adjustment, the spacing between the characters in the character pair to be adjusted, which is displayed on the interface, will be changed along with the change of the spacing value.

In some embodiments, adjusting the spacing value of the character pair to be adjusted from the first spacing value to the final spacing value may include adjusting the spacing value from the first spacing value to a second spacing value, and determining whether the second spacing value satisfies preset criteria. If the second spacing value satisfies the preset criteria, save the second spacing value as the final spacing value. If the second spacing value does not satisfy the preset criteria, further adjust the spacing value from the second spacing value to a third spacing value, and determine whether the third spacing value satisfies the preset criteria. Repeat the adjusting and determining steps until an N-th spacing value that satisfies the preset criteria may be obtained and then save the N-th spacing value as the final spacing value, where N is an integer larger than 2.

In some embodiments, the preset criteria may be criteria that satisfy the user. For example, the spacing value of the character pair to be adjusted, such as A and V, is adjusted from the first spacing value, such as 40, to the second spacing value, such as 26. If the display effect of the character pair to be adjusted on the interface, which now has the second spacing value, satisfies the user, the spacing value is not adjusted any more. The character pair A and V, and the second spacing value as the final spacing value, are saved. If the spacing value is 26, and the base of the font kit is 256, such a combination indicates that the spacing between the characters in the character pair 26/256 of a character width. That is, when the spacing value of the character pair A and V is adjusted from the first spacing value of 40 to the second spacing value of 26, the spacing between the characters in the character pair is reduced by 40/256−26/256=14/256. In other words, after the adjustment, a distance between the characters A and V in the character pair is reduced by 14/256.

In some embodiments, saving the character pair A and V and the second spacing value may include: acquiring character codes of the character pair A and V and the second spacing value; and converting the character codes into corresponding indexes according to a code table of the Truetype font kit. For example, if the character code of the character A is a and the character code of the character V is v, then after the conversion, the index corresponding to the character code a may be al and the index corresponding to the character code v may be v1, and the indexes al and v1 together form an index pair. Saving the character pair A and V and the second spacing value may further include saving the index pair and the second spacing value in the KERN table of the Truetype font kit.

In some embodiments, after the spacing value of the character pair to be adjusted, such as A and V, is adjusted from the first spacing value, such as 40, to the second spacing value, such as 26, if the display effect of the character pair to be adjusted displayed on the interface does not satisfy the user, the spacing value may need to be further adjusted. Such adjustment may be repeated until an N-th spacing value that satisfies the preset criteria is obtained, where the first spacing value is larger than the second spacing value, and the second spacing value is larger than the N-th spacing value.

In some embodiments, during the process of adjusting the spacing value to the N-th spacing value that satisfies the preset criteria, the spacing between the characters in the character pair, such as A and V, displayed on the interface may be changed when the spacing value of the character pair is adjusted. For example, when the spacing value of the character pair A and V is adjusted from 40 to 26, the spacing between the characters A and V displayed on the interface may also be changed from 40 to 26. In the process of adjusting the spacing value of the character pair A and V, both the base and the frame of the character in the font kit may not change.

In some embodiments, the system 200 may further comprise a second adjusting module (not shown) configured to: adjust the spacing value of the character pair to be adjusted by a positive number or a negative number; adjust positions of the characters in the character pair according to the adjusted spacing value, and re-plot by drawing according to the adjusted spacing value to obtain a plotting result; and adjust the spacing value according to the plotting result until the N-th spacing value that satisfies the preset criteria is obtained.

In some embodiments, during the adjustment process, adjusting the spacing value may include making numerical change according to an adjusting interface for the spacing value. A positive number may represent increasing the spacing between the characters, and a negative number may represent decreasing the spacing between the characters.

According to the adjusted spacing value, the plotting module 203 may again plot the glyphs of the characters on the interface to obtain a plotting result. According to the plotting result, it may be determined whether the glyphs meet the user's criteria. If the plotting result meets the user's criteria, then the adjusted spacing value may not need to be further changed, and the adjusted spacing value and the corresponding character pair may be saved. If the plotting result does not meet the user's criteria, then the first adjusting module 204 may adjust the spacing value until the adjusted spacing value satisfies the user's criteria. The spacing value that satisfies the user's criteria and the corresponding pair of characters may be saved, and the glyphs of the characters corresponding to the adjusted spacing value may be plotted on the interface to be previewed by the user. In some embodiments, the saving may include: acquiring the character codes of the character pair A and V and the adjusted spacing value; converting the character codes into corresponding indexes according to the code table of the Truetype font kit; and saving the spacing value and an index pair comprising the corresponding indexes in the KERN table of the Truetype font kit.

In the embodiments described above, the first spacing value is larger than the second spacing value, and the second spacing value is larger than the N-th spacing value. In other embodiments, the first spacing value may be smaller than the second spacing value, and the second spacing value may be smaller than the N-th spacing value. Methods and systems disclosed above may also be applicable to such other embodiments.

Methods and systems consistent with embodiments of the present disclosure may have following technical effects.

First, when adjusting spacing of a character pair, coding information about the character pair to be adjusted is read out, glyph data of the character pair may be read out according to the coding information, and the read out glyph data may be plotted on an interface by drawing. Thus, there is no need to repeatedly export, modify, import, and install when result displayed on the interface after adjustment does not satisfy the user's criteria. Consequently, the workload of adjusting spacing between characters may be reduced and the work efficiency improved.

Second, when adjusting spacing of a character pair, the read out glyph data may be plotted on the interface by drawing. Thus, the adjustment result can be immediately previewed.

Consistent with embodiments of the present disclosure, a computer is provided which is able to carry out the methods for adjusting spacing between characters. The computer may be, for example, a personal computer, a workstation, a parallel computer, or a super computer. The computer may comprise one or more input devices, such as a keyboard, a mouse, or a control panel, for receiving user instructions or user-set parameters. The computer may also comprise one or more output devices, such as a display or a printer. The display may be used to present an interface for the user to, for example, indicate whether the displayed character pair is satisfactory.

Consistent with embodiments of the present disclosure, one or more non-transitory storage medium storing a computer program are provided to implement the system and method for adjusting spacing between characters. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be a semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for adjusting spacing between characters, comprising:
determining a character pair from a font kit, the character pair comprising two characters and having a spacing value;
acquiring glyph outline data of the character pair;
plotting the glyph outline data of the character pair, and displaying the character pair on an interface;
adjusting the spacing value from a first spacing value to a second spacing value; and
changing, while adjusting the spacing value, a spacing between the two characters displayed on the interface.

2. The method according to claim 1, wherein adjusting the spacing value from the first spacing value to the second spacing value includes:
determining whether the second spacing value satisfies preset criteria,
if yes, saving the second spacing value; and
if no,
adjusting the spacing value until an N-th spacing value that satisfies the preset criteria is obtained, and
saving the N-th spacing value, N being an integer larger than 2.

3. The method according to claim 2, wherein adjusting the spacing value until the N-th spacing value that satisfies the preset criteria is obtained includes:
adjusting the spacing value by a positive number or a negative number;
adjusting positions of the two characters in the character pair according to the adjusted spacing value;
plotting the glyph outline data of the character pair by drawing according to the adjusted spacing value, to obtain a plotting result; and
adjusting the spacing value according to the plotting result until the N-th spacing value that satisfies the preset criteria is obtained.

4. The method according to claim 1, wherein acquiring the glyph outline data of the character pair includes:
reading out coding information of the character pair; and
reading out the glyph outline date of the character pair from the font kit according to the coding information.

5. The method according to claim 1, wherein plotting the glyph outline data of the character pair includes:
plotting the glyph outline data of the character pair by drawing according to an existing spacing value of an existing character pair in the font kit.

6. A system for adjusting spacing between characters, comprising:
a determining module, configured to determine a character pair from a font kit, the character pair comprising two characters and having a spacing value;
an acquiring module, configured to acquire glyph outline data of the character pair;
a plotting module, configured to plot the glyph outline data of the character pair, and display the character pair on an interface; and
a first adjusting module, configured to adjust the spacing value of the character pair from a first spacing value to a second spacing value, and change, while adjusting the spacing value, a spacing between the two characters displayed on the interface along with a change of the spacing value.

7. The system according to claim 6, the first adjusting module is further configured to:
determine whether the second spacing value satisfies preset criteria,
if yes, save the second spacing value; and
if no,
adjust the spacing value until an N-th spacing value that satisfies the preset criteria is obtained, and
save the N-th spacing value, N being an integer larger than 2.

8. The system according to claim 7, further comprising a second adjusting module configured to:
adjust the spacing value by a positive number or a negative number;
adjust positions of the two characters in the character pair according to the adjusted spacing value;
plot the glyph outline data of the character pair by drawing according to the adjusted spacing value, to obtain a plotting result; and
adjust the spacing value according to the plotting result until the N-th spacing value that satisfies the preset criteria is obtained.

9. The system according to claim 6, wherein the acquiring module comprises:
a first reading sub-module, configured to read out coding information of the character pair; and
a second reading sub-module, configured to read out the glyph outline data of the character pair from the font kit according to the encoded information.

10. The system according to claim 6, wherein the plotting module is further configured to:
plot the glyph outline data of the character pair by drawing according to an existing spacing value of an existing character pair in the font kit.

11. A non-transitory computer-readable storage medium with an executable program stored thereon, wherein the program, when executed by at least one processor, causes a computing device to perform operations comprising:
determining a character pair from a font kit, the character pair comprising two characters and having a spacing value;
acquiring glyph outline data of the character pair;
plotting the glyph outline data of the character pair, and displaying the character pair on an interface;
adjusting the spacing value from a first spacing value to a second spacing value; and
changing, while adjusting the spacing value, a spacing between the two characters displayed on the interface.

12. The storage medium according to claim 11, wherein adjusting the spacing value from the first spacing value to the second spacing value includes:
determining whether the second spacing value satisfies preset criteria,
if yes, saving the second spacing value; and
if no,
adjusting the spacing value until an Nth spacing value that satisfies the preset criteria is obtained, and
saving the N-th spacing value, N being an integer larger than 2.

13. The storage medium according to claim 12, wherein adjusting the spacing value until the N-th spacing value that satisfies the preset criteria is obtained includes:
adjusting the spacing value by a positive number or a negative number;
adjusting positions of the two characters in the character pair according to the adjusted spacing value;
plotting the glyph outline data of the character pair by drawing according to the adjusted spacing value, to obtain a plotting result; and
adjusting the spacing value according to the plotting result until the N-th spacing value that satisfies the preset criteria is obtained.

14. The storage medium according to claim 11, wherein acquiring the glyph outline data of the character pair includes:
reading out coding information of the character pair; and
reading out the glyph outline date of the character pair from the font kit according to the coding information.

15. The storage medium according to claim 11, wherein plotting the glyph outline data of the character pair includes:
plotting the glyph outline data of the character pair by drawing according to an existing spacing value of an existing character pair in the font kit.
